(19) United States
(12) Patent Application Publication
(10) Pub. No.: US 2018/0318738 A1
(43) Pub. Date: Nov. 8, 2018

(54) ENHANCED FILTER INSTALLATION

(71) Applicant: Haier US Appliance Solutions, Inc., Wilmington, DE (US)

(72) Inventors: Gregory Sergeevich Chernov, Louisville, KY (US); Andrew Reinhard Krause, Louisville, KY (US)

(21) Appl. No.: 15/586,348

(22) Filed: May 4, 2017

(51) Int. Cl. B01D 35/30

(52) U.S. Cl. CPC B01D 35/30; B01D 2201/4023; B01D 2201/4007

(57) ABSTRACT

A filter assembly with one or more features that enhance installation, inspection, and replacement of filter. A manifold is provided with a bracket. The filter housing includes cam followers that interact with the bracket during installation and removal of the filter.

### FIELD OF THE INVENTION

The subject matter of the present disclosure relates to a device that facilitates filter installation and replacement.

### BACKGROUND OF THE INVENTION

A conventional filter assembly for liquid filtration includes a filter contained within a housing and secured to a manifold. The filter housing can be removed from the manifold in order to replace the filter. The user may decide to replace the filter at timed intervals or when an inspection determines the filter is spent. Several factors can make such inspection and replacement of the filter challenging.

For water filtration, e.g., potable water filtration, the filter assembly may be located at the point of entry into residential or commercial structure so as to provide filtration of all water being used therein. The filter assembly may also be installed at the point of use such as under a lavatory or in combination with a water dispenser such as a water fountain or in a refrigerator. Depending upon the location of the installation, access to the filter assembly for replacement of the filter may be limited. Locations in the crawl space of a residence, for example, may be particularly difficult to service due to the limited space available.

Typically, the conventional filter assembly includes coarse threads for complementary connection between the filter housing and the manifold. An o-ring positioned on the filter housing near the threads and around the opening provides for a seal. The threads can be difficult to properly align so as to avoid cross-threading when installing the filter housing. Maintaining the proper positioning of the o-ring during installation can also be challenging because rotation of the filter housing against the manifold may undesirably displace the o-ring. Once installed, if the filter is not regularly replaced, the threads may lock and the o-ring may stick.

Usually, to tighten or loosen the filter housing, a separate tool such as a specially adapted wrench is required. The user must secure the tool when not in use. Conventional tools such as wrenches and pliers may not be large enough to grasp the filter housing so misplacing the special tool creates a problem.

For some applications, the filter and filter housing may be relatively large and heavy, which can increase the difficulty of properly aligning the threads and holding these parts in place during installation. During removal, once the threads are disengaged, the filter housing and filter may also be filled with liquid—further increasing the weight and chances of dropping the removed assembly.

These and other challenges can make filter inspection and replacement very difficult. Accordingly, a filter assembly with features that facilitate one or more of aspects of filter installation, inspection, and replacement would be useful.

### BRIEF DESCRIPTION OF THE INVENTION

The present invention provides a filter assembly with one or more features that enhance installation, inspection, and replacement of filter. A manifold is provided with a bracket. The filter housing includes cam followers that interact with the bracket during installation and removal of the filter. Additional aspects and advantages of the invention will be set forth in part in the following description, or may be apparent from the description, or may be learned through practice of the invention.

In one exemplary aspect, the present invention provides a filter assembly that includes a filter housing defining an internal chamber. A pair of cam followers are positioned on opposing sides of the filter housing. A manifold has an inlet for liquid flow into the filter assembly and an outlet for liquid flow out of the assembly. The manifold has a manifold opening for receipt of the filter housing,

A pair of pivot joints are located on opposing sides of the manifold. A bracket is attached to the pivot joints. The bracket is rotatable about an axis of rotation extending through the pivot joints. The bracket includes a main body extending partially around the manifold and connected to the pivot joints. A pair of cam slots are positioned on opposing sides of the manifold. The cam slots lie within parallel planes that are orthogonal to the axis of rotation of the bracket. Each cam slot is configured for receipt of one of the cam followers therein. Each cam slot is defined by an arcuate-shaped opening in the bracket created by a top guide and a bottom guide, wherein the top guide is shorter than the bottom guide.

These and other features, aspects and advantages of the present invention will become better understood with reference to the following description and appended claims. The accompanying drawings, which are incorporated in and constitute a part of this specification, illustrate embodiments of the invention and, together with the description, serve to explain the principles of the invention.

### BRIEF DESCRIPTION OF THE DRAWINGS

A full and enabling disclosure of the present invention, including the best mode thereof, directed to one of ordinary skill in the art, is set forth in the specification, which makes reference to the appended figures, in which:

FIG. 1 provides a perspective view of an exemplary embodiment of a filter assembly of the present invention.

FIG. 2 is a rear view of the exemplary filter assembly of FIG. 1.

FIG. 3 is a front view of the exemplary filter assembly of FIG. 1.

FIG. 4 is a side view of the exemplary filter assembly of FIG. 1.

FIG. 5 is a close up, side view of an exemplary manifold as may be used with the filter assembly of FIG. 1.

FIG. 6 is an even closer view of a portion of the exemplary manifold of FIG. 5. In FIGS. 5 and 6, for purposes of illustration, a cam follower is not shown.

FIGS. 7 and 8 are additional side views of the exemplary filter assembly of FIG. 1.

FIGS. 9 and 10 are perspective and partial cross-sectional views of the exemplary filter assembly of FIG. 1.

FIG. 11 is a perspective view of an exemplary component of the present invention.

FIGS. 12 and 13 provide partial side views of another exemplary embodiment of the present invention.

The use of the same or similar reference numerals in the figures denote the same or similar features unless indicated otherwise.

### DETAILED DESCRIPTION OF THE INVENTION

Reference now will be made in detail to embodiments of the invention, one or more examples of which are illustrated in the drawings. Each example is provided by way of explanation of the invention, not limitation of the invention. In fact, it will be apparent to those skilled in the art that various modifications and variations can be made in the present invention without departing from the scope or spirit of the invention. For instance, features illustrated or described as part of one embodiment can be used with another embodiment to yield a still further embodiment. Thus, it is intended that the present invention covers such modifications and variations as come within the scope of the appended claims and their equivalents.

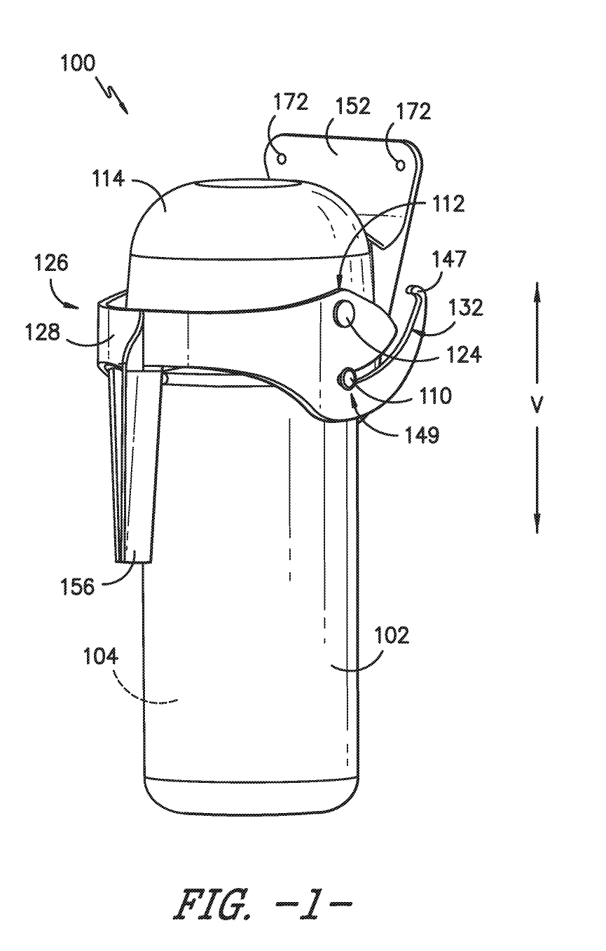

FIGS. 1, 2, 3 and 4 provide various views of an exemplary filter assembly 100 of the present invention—each showing a closed position with a filter 106 installed. Filter assembly 100 may be used e.g., with potable water, fuels, or other liquid filtration applications. Removal of undesired components (e.g., sediment, chemicals, microorganisms) from the liquid may be accomplished by combinations of mechanical filtration, adsorption, or others processes. The present invention is not limited to the particular shape of filter assembly 100 shown in the figures. As will be understood by one of ordinary skill in the art using the teachings disclosed herein, other shapes and configurations may be used as well. Additionally, the embodiments of the present invention will be described with reference to the filtration of potable water. However, the present invention may be used for filtering other liquids as well.

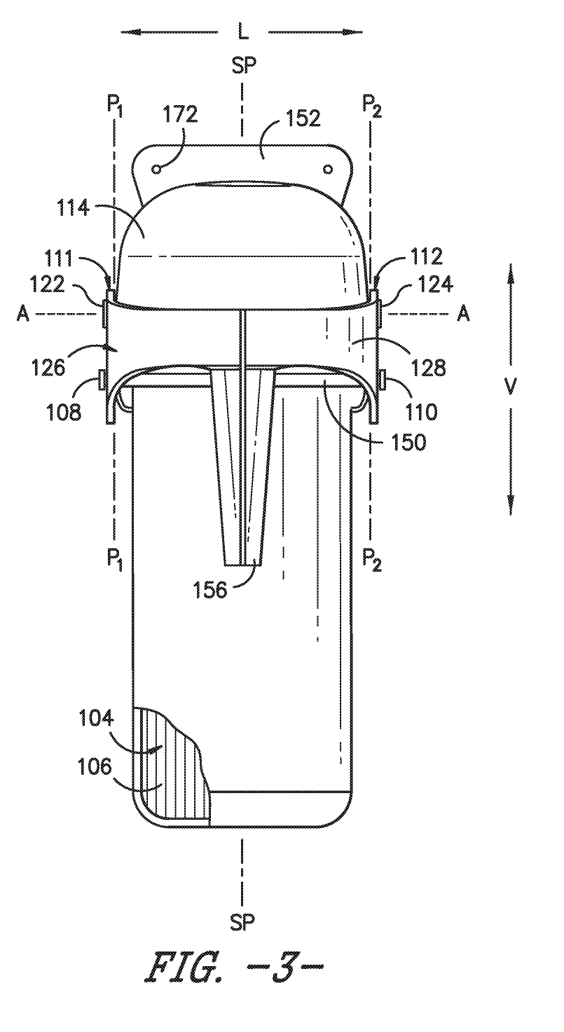

Filter assembly 100 includes a filter housing 102 that is selectively removable from a manifold 114. Filter housing 102 includes a filter media 106 (FIG. 3) positioned within an internal chamber 104 defined therein. Filter media may be constructed from a variety of materials including paper, various textiles, adsorption media, and others depending upon the filtration desired.

For potable water, filter assembly 100 might be installed near the point of entry of the water supply into a home or a commercial structure. Alternatively, filter assembly 100 might be installed under a kitchen sink or in a bathroom lavatory. Other installations may be used as well. Manifold 114 has an inlet 116 for fluid flow into filter assembly 100. Internal features of manifold 114, filter housing 102, and/or filter media 106 (not shown) route the flow of liquid through the filter media 106 where filtration takes place. The filtered liquid can travel out of filter assembly 100 through outlet 118 of manifold 114. Inlet 116 and outlet 118 may be connected with e.g., piping that distributes potable water within a structure.

A mounting base 152 is connected with manifold 114. Mounting base 152 includes several apertures 172 that may be used with fasteners to secure filter assembly 100 to a surface. Other configurations for mounting or hanging filter assembly 100 may be used as well.

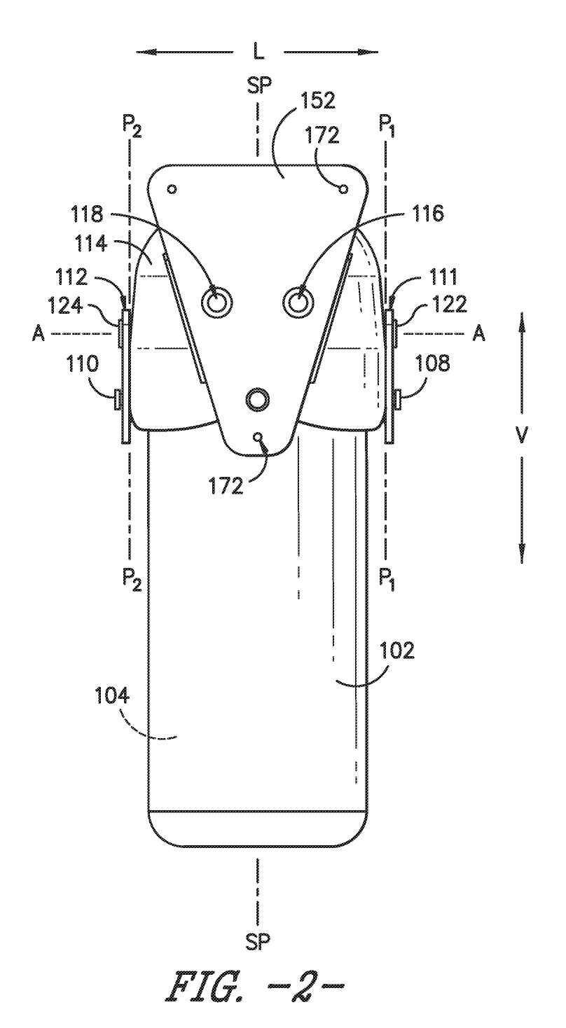

For this exemplary embodiment, filter assembly 100 defines a right symmetry plane SP that divides assembly 100 into opposing sides and about which the main components of assembly 100 are symmetrical. A pair of cam followers 108, 110 are positioned on opposing sides of assembly 100. As will be described herein, cam followers 108, 110 interact with cam slots 130, 132 positioned on opposing sides 111, 112, respectively, of bracket 126 to secure filter housing 102 to manifold 114. During installation, inspection, and replacement of filter media 106 by manipulation of bracket 126, the cam slots 130, 132 and their respective sides 111, 112 rotate but remain within a pair of parallel planes P1 and P2 as illustrated in FIG. 2. Parallel planes P1 and P2 are orthogonal to axis of rotation A-A and parallel to each other.

Bracket 126 includes a handle 156 whereby a user may rotate bracket 126 during the installation and removal of filter housing 102. Handle 156 is connected to a main body 128 of bracket 126. Main body 128 extends partially around manifold 114 and is connected with a pair of pivot joints 122, 124 located on opposing sides of manifold 114. Pivot joints 122, 124 provide that bracket 126 is rotatable about axis of rotation A-A that that extends through joints 122, 124 and is orthogonal to symmetry plane SP.

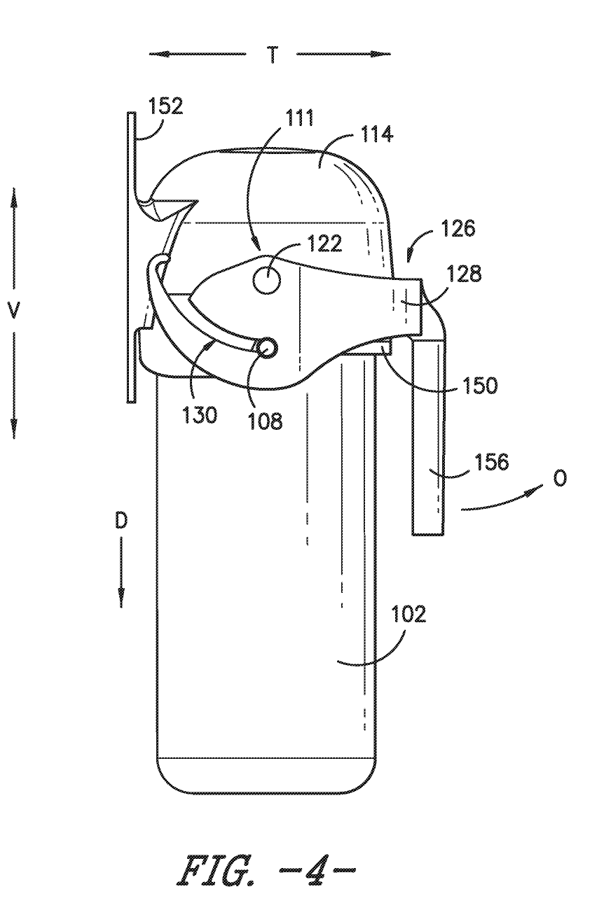

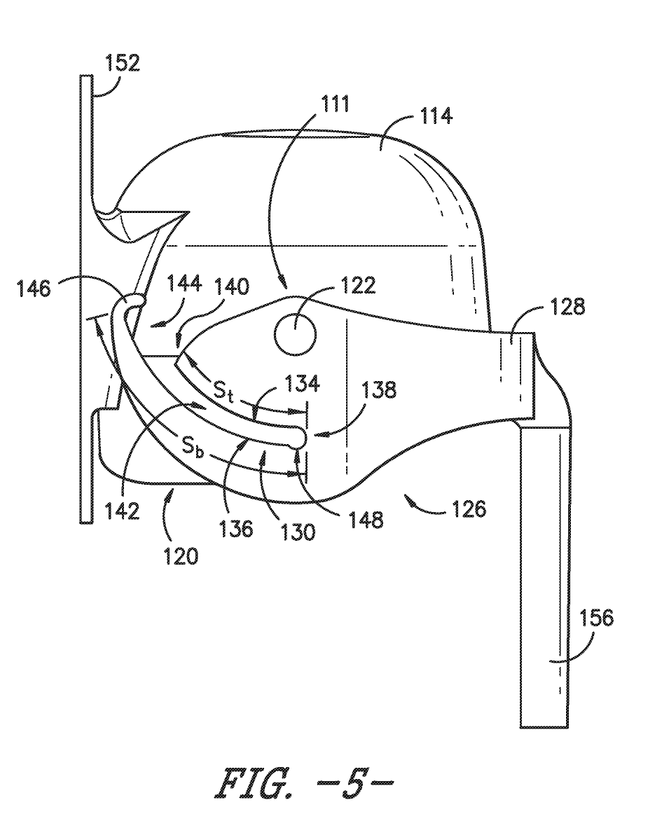

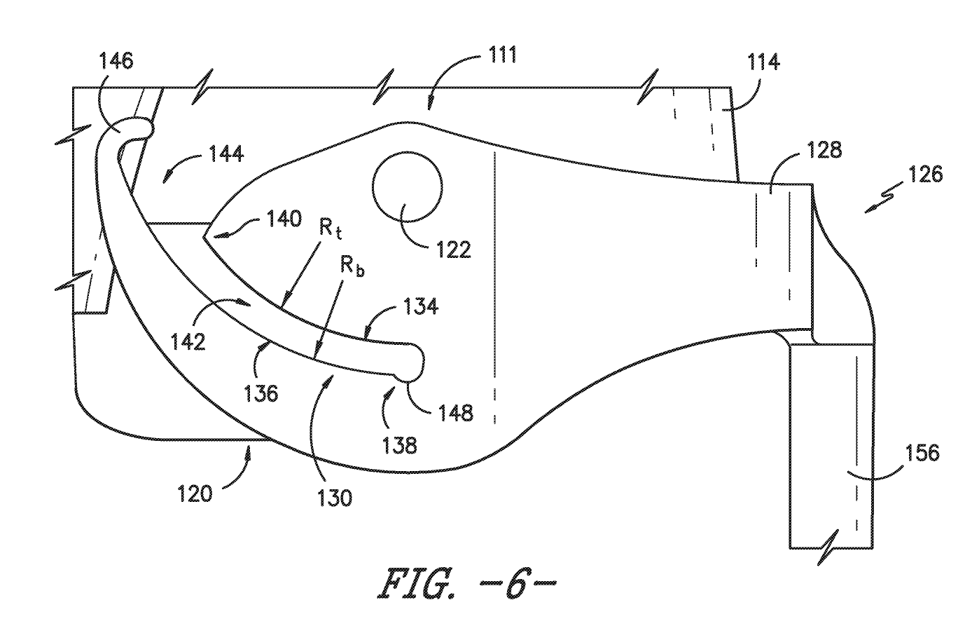

FIGS. 4, 5, and 6 illustrate side 111 of bracket 126 that will be used to describe its construction. Cam follower 108 is not shown in FIGS. 5 and 6 for purposes of illustration. As bracket 126 symmetrical about symmetry plane SP, it will be understood that the construction is identical for both sides 111, 112 of bracket 126 including cam slots 130 and 132.

As shown, cam slot 130 is configured for receipt of cam follower 108 and includes an arcuate-shape opening 142 defined by a top guide 134 and a bottom guide 136 in side 111 of bracket 126. Cam slot 130 includes a first end 138 and a second end 140. Top guide 134 and bottom guide 136 are connected at first end 138. The length of top guide 134, Sₜ, is shorter than bottom guide 136, S_{b}, which creates a gap 144 at second end 140. In one exemplary embodiment, the length of top guide 134 is no more than 80 percent of the length of bottom guide 136. In still another embodiment, the length of top guide 134 is no more than 60 percent of the length of bottom guide 136.

In addition, for this embodiment, the radius of curvature, Rₜ, for the top guide 134 is less than the radius of curvature for the bottom guide, R_{b}. As such, the distance between top guide 134 and bottom guide 136 increases along a direction from first end 138 towards second end 140. A hook 146 is positioned at the end of bottom guide 136 and is displaced from second end 140 of cam slot 130 by gap 144. A notch 148 is positioned near first end of cam slot 130.

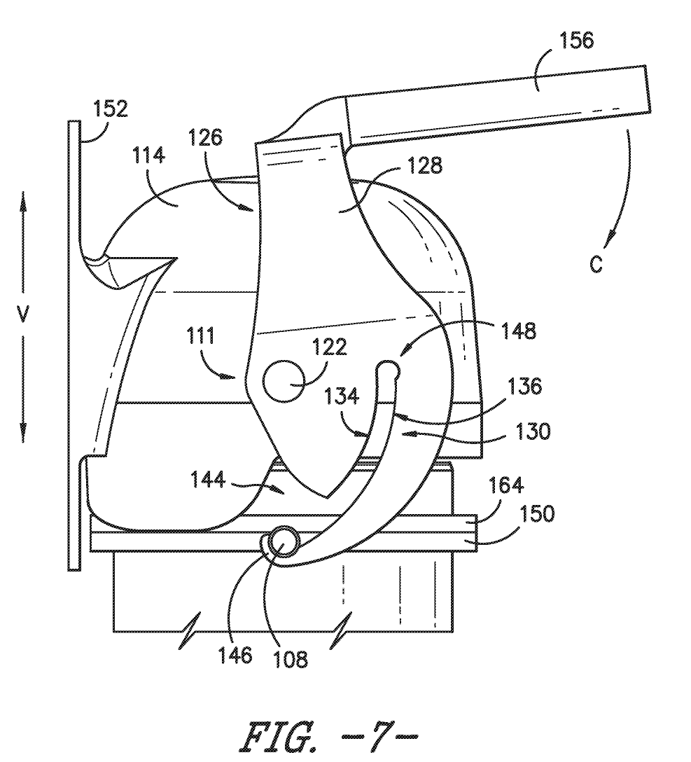

FIG. 7 illustrates an open position of bracket 126. In the open position, filter housing 102 with filter media 106 can hang from hooks 146, 147 on the opposing sides of manifold 114. As shown, cam followers 108, 110 fit into hooks 146,147 so as to secure filter housing 102 in place. Accordingly, during installation of filter housing 102 with a new filter media 106, the user can conveniently hang such in place. Hooks 146, 147 can be particularly convenient in spaces where e.g., the user may be lifting filter housing overhead or attempting to manipulate the same in a crawlspace or cabinet. Similarly, when removing filter housing 102 to inspect or replace filter media 106, filter housing 102 may be filled with liquid. Hooks 146, 147 can hold filter housing 102 in place after it is disengaged from manifold 114 so as to e.g., prevent spills while the user prepares to replace filter media 106. In addition, gap 144 ensures that cam followers 108 and 110 can be readily placed onto bottom guide 136 and into hooks 146, 147.

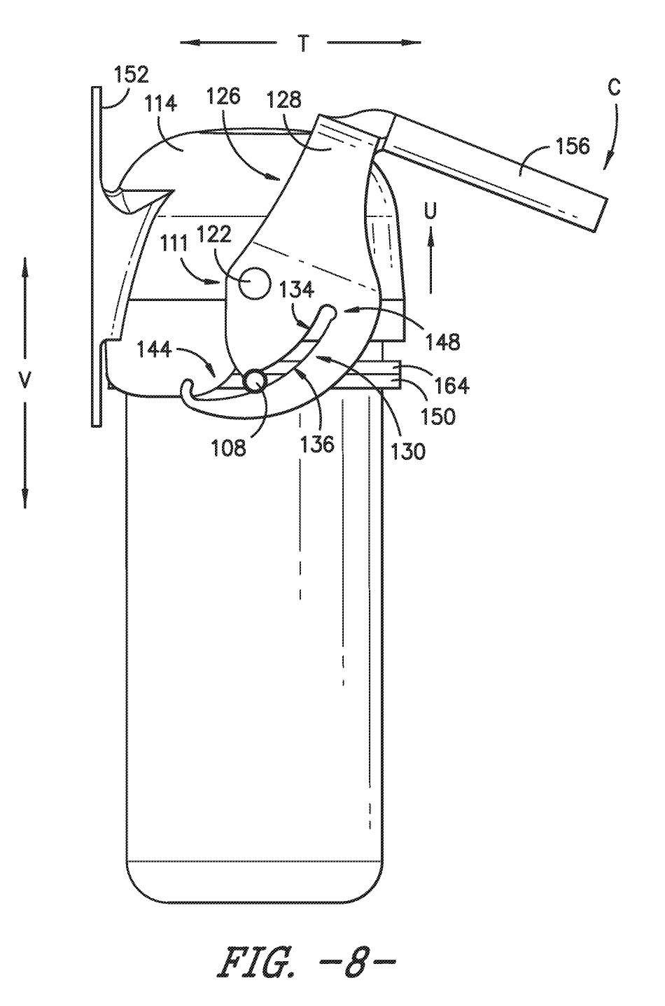

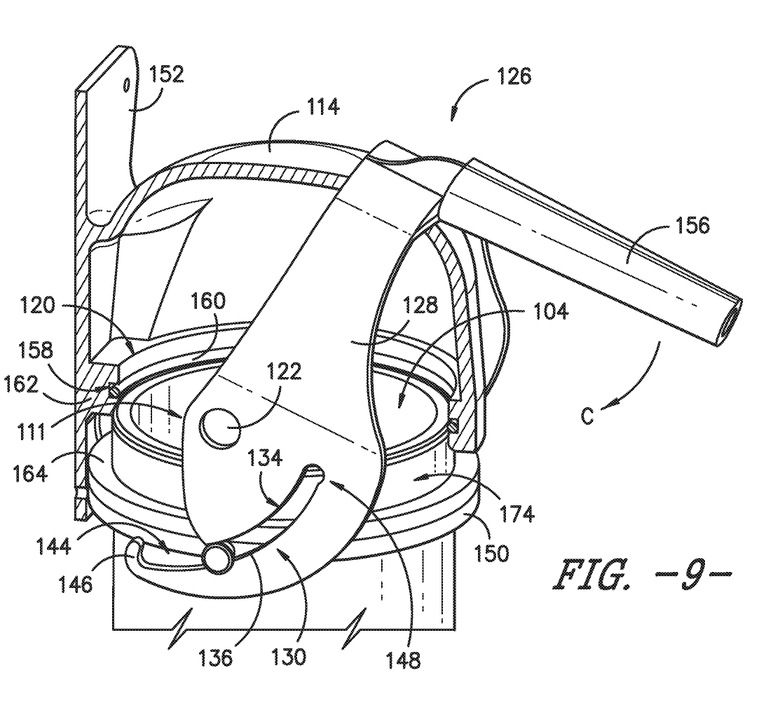

FIGS. 8 and 9 depict the position of filter housing 102 after the user has moved handle 156 in the direction of arrow C (FIG. 8) towards filter housing 102. Bracket rotates about pivot joints 122, 124. Such rotational movement causes cam followers 108, 110 to dislodge from hooks 146, 147 and slide along cam slots 130, 132, respectively. The particular curvature of cam slots 130, 132 causes filter housing 102 with filter media 106 to be lifted upwardly (arrow U) towards filter manifold 114. Bottom guide 136 provides an upward force on cam followers 108, 110 thereby lifting filter housing 102 and filter media 106. As filter housing 102 moves upwardly, its top 174 is aligned by interference with manifold flange 162, which surrounds and projects into manifold opening 120. Such interference ensures that filter housing 102 is properly positioned relative to manifold 114.

As the user continues the movement of handle 156 along arrow C (FIG. 8) towards filter housing 102, bracket 126 eventually reaches the closed position shown in FIGS. 1 through 4 and FIG. 10. In the closed position, cam followers 108, 110 are received into notches 148, 149 of cam slots 130, 132. Notches 148, 149 releasably lock cam followers 108, 110 into position and thereby secure filter housing 102 with filter media 106 into place in filter manifold 114.

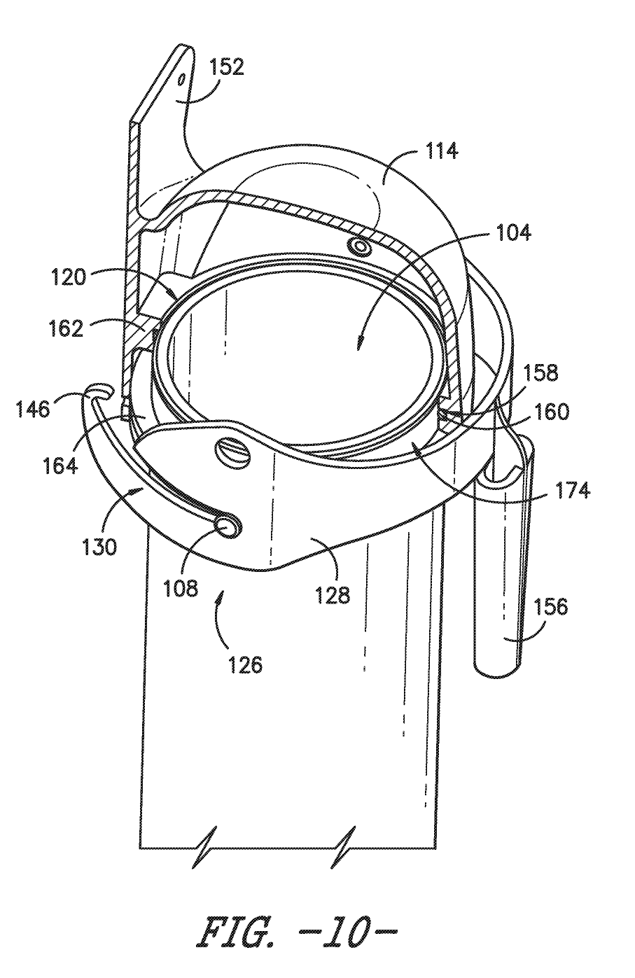

As shown in FIGS. 9 and 10, filter housing 102 includes a filter housing flange 164 that encircles filter housing 102 and projects away from filter housing 102. In the closed position, filter housing flange 164 abuts manifold flange 162 as shown to help positively secure the position of filter housing 102 within manifold 114. Additionally, filter manifold 102 defines a groove 158 surrounding manifold opening 120. A seal 160 is positioned in groove 158 and contacts filter housing 102 when in the closed position as to prevent fluid leaks. Groove 158 and seal 160 are provided by way of example only. Other configurations for preventing fluid leaks may be used as well. For this exemplary embodiment, the configuration of flanges 162, 164 and seal 160 help prevent leaks, ensure seal 160 is properly oriented during installation, and helps prevent filter housing 102 from sticking in place during removal.

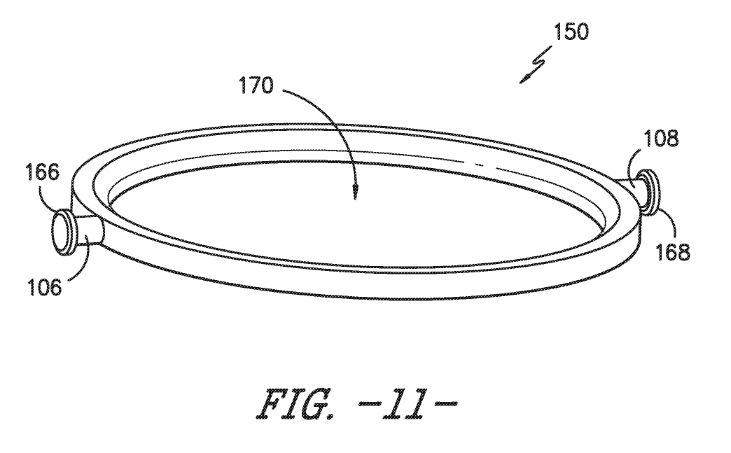

Cam followers 108, 110 are positioned on opposing sides of filter housing 102 as previously described. A variety of constructions may be used to position cam followers 108, 110 on filter housing 102. FIG. 11 depicts ring 150 having an opening 170 into which filter housing 102 may be received so as to support housing 102 on ring 150. For this exemplary embodiment, cam followers 108, 110 include washers 166, 168 that assist in aligning cam followers 108, 110 as they move along slots 130, 132. Ring 150 may be constructed from a variety of materials such as e.g., metal, reinforced polymers, and others.

To open filter housing 102 and inspect or replace filter media 106, the user moves bracket 126 along the direction of arrow O (FIG. 4) so cause rotation about pivot joints 122, 124. Cam followers 108, 110 will dislodge from notches 148, 149 and ride along cam slots 130, 132. Top guide 134 will provide a downward force on cam followers 108, 110 to help dislodge filter housing 102 (arrow D in FIG. 4). Cam followers 108, 110 will eventually reach hooks 146, 147 from which filter housing 102 and filter media 106 can hang as previously described.

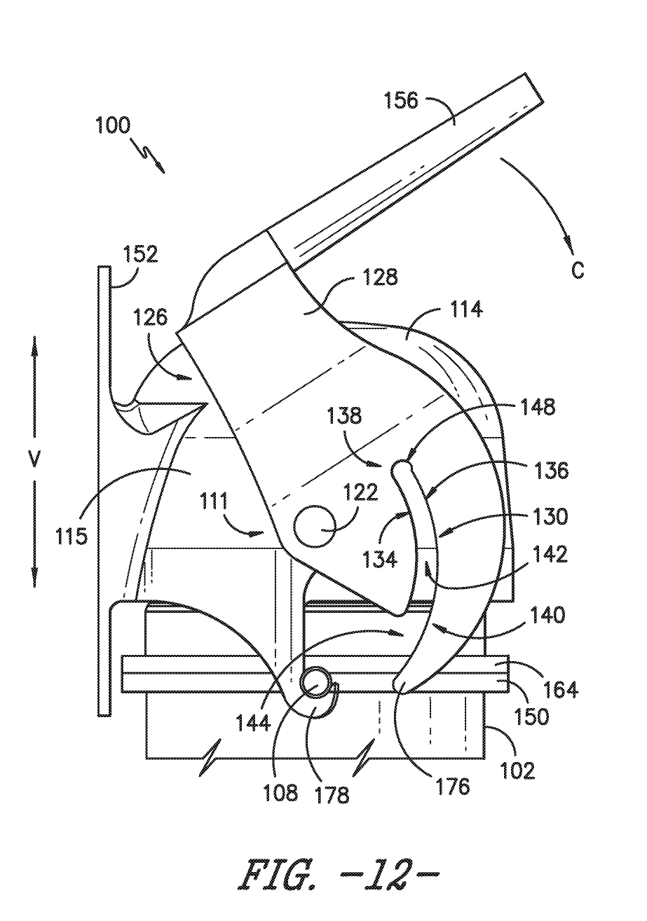

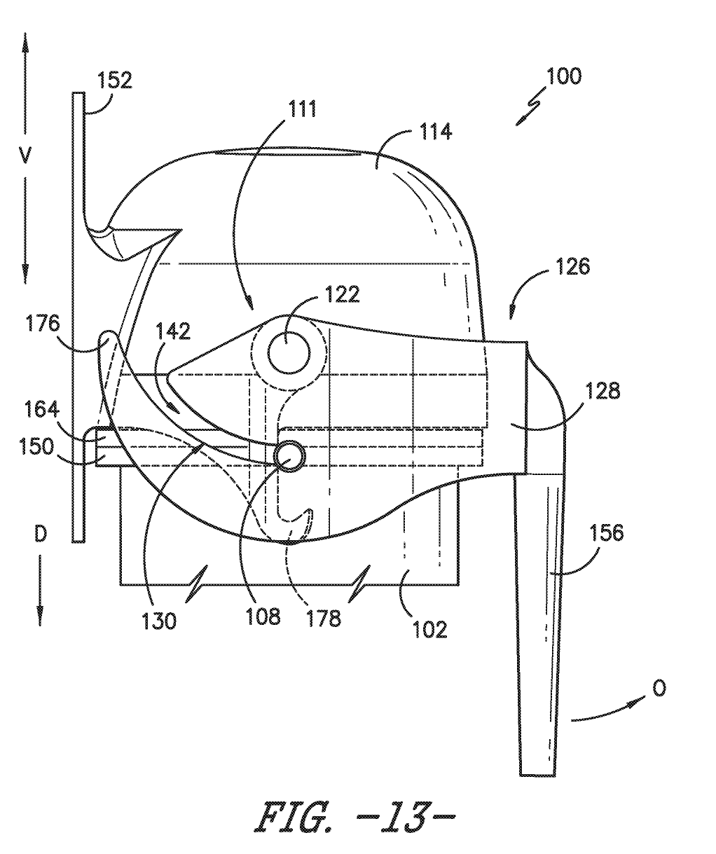

FIGS. 12 and 13 provide sides view of another exemplary embodiment of filter assembly 100. FIG. 12 depicts bracket 126 in an open position while FIG. 13 depicts bracket 126 in a closed position. As with the embodiment of FIGS. 1 through 11, the embodiment of FIGS. 12 and 13 is symmetrical about a right symmetry plane and is similar in all respects to the embodiment of FIGS. 1 through 11 except as will now be described using one side.

For the embodiment of FIGS. 12 and 13, manifold 114 includes hook 178 that extends downwardly along vertical direction V from main body 115 of manifold 114 and opens upwardly as shown. Unlike the previous embodiment, end 176 of bottom guide 136 does not include a hook adjacent to gap 114. Instead, cam 108 is received onto hook 178 during insertion and removal of filter housing 102.

Accordingly, to install filter housing 102, a user hangs housing 102 from manifold 114 using cams and hooks on both sides including cam follower 108 and hook 178. Handle 156 is then used to rotate bracket 126 (arrow C). Cam slots on both sides of bracket 126, including cam slot 130, engage the cam followers to lift filter housing 102 into position in manifold 114. A pair of notches, including notch 148, releasably lock the cam followers into position and thereby secure filter housing 102 with filter media 106 into place in filter manifold 114. Filter housing 102 can be released by moving handle along the direction of arrow O in a manner as previously described.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they include structural elements that do not differ from the literal language of the claims, or if they include equivalent structural elements with insubstantial differences from the literal languages of the claims.

What is claimed is:

1. A filter assembly, comprising:
a filter housing defining an internal chamber;
a pair of cam followers positioned on opposing sides of the filter housing;
a manifold having an inlet for liquid flow into the filter assembly and an outlet for liquid flow out of the assembly, the manifold having a manifold opening for receipt of the filter housing,
a pair of pivot joints located on opposing sides of the manifold;
a bracket attached to the pivot joints, the bracket rotatable about an axis of rotation extending through the pivot joints, the bracket comprising
a main body extending partially around the manifold and connected to the pivot joints; and
a pair of cam slots positioned on opposing sides of the manifold, the cam slots lying within parallel planes that are orthogonal to the axis of rotation of the bracket, each cam slot configured for receipt of one of the cam followers therein, each cam slot defined by an arcuate-shaped opening in the bracket created by a top guide and a bottom guide, wherein the top guide is shorter than the bottom guide.

2. The filter assembly of claim 1, wherein for each cam slot the top guide and bottom guide are connected at a first end of the cam slot and define a gap at a second end of the cam slot, the gap configured for receipt of one of the cam followers.

3. The filter assembly of claim 2, wherein the top guide has a top guide length and the bottom guide has a bottom guide length, and wherein the top guide length is no more than 80 percent of the bottom guide length.

4. The filter assembly of claim 3, wherein the top guide has a top guide radius of curvature and the bottom guide has a bottom guide radius of curvature, and wherein the top guide radius of curvature is less than the bottom guide radius of curvature.

5. The filter assembly of claim 1, wherein for each cam slot the top guide and bottom guide are connected at a first end of the cam slot and wherein the distance between the top guide and the bottom guide increases along a direction from the first end to the second end.

6. The filter assembly of claim 1, wherein for each cam slot the top guide and bottom guide are connected at a first end of the cam slot, define a notch at the first end of the cam slot, and define a gap at a second end of the cam slot, the gap and notch configured for receipt of one of the cam followers.

7. The filter assembly of claim 1, wherein for each cam slot the top guide and bottom guide are connected at a first end of the cam slot and define a gap at a second end, and wherein the bottom guide defines a hook separated from the second end by the gap.

8. The filter assembly of claim 1, wherein each cam slot further comprises a notch at the first end, each notch configured to receive one of the cam followers so as to releasably lock the filter housing into position.

9. The filter assembly of claim 1, further comprising a ring supported on the filter housing and surrounding the internal chamber, wherein the cam followers are attached to the ring.

10. The filter assembly of claim 9, wherein the ring is integrally formed with the filter housing.

11. The filter assembly of claim 10, wherein the ring comprises a metal or a reinforced polymer.

12. The filter assembly of claim 1, further comprising a mounting base attached to the manifold and configured for mounting the filter assembly to a surface.

13. The filter assembly of claim 1, further comprising a handle attached to the bracket at a location midway of the pivot joints.

14. The filter assembly of claim 1, wherein the manifold defines a groove surrounding the opening of the manifold, and further comprising a seal received in the groove.

15. The filter assembly of claim 1, wherein the manifold defines a manifold flange that surrounds and projects into the opening of the manifold.

16. The filter assembly of claim 15, wherein the filter housing defines a filter housing flange that encircles the filter housing and projects away from the filter housing, the filter housing flange configured to abut the manifold flange when the filter housing is installed into the manifold.

17. The filter assembly of claim 16, wherein the manifold flange defines a groove surrounding the manifold opening, and further comprising a seal positioned in the groove.

18. The filter assembly of claim 1, further comprising a filter media located in the internal chamber of the filter housing.

19. The filter assembly of claim 1, further comprising a pair of hooks positioned on opposing sides of the manifold, each hook positioned below one of the pivot joints.
